(19) United States
(12) Patent Application Publication
(10) Pub. No.: US 2011/0047136 A1
(43) Pub. Date: Feb. 24, 2011

(54) Method For One-Click Exclusion Of Undesired Search Engine Query Results Without Clustering Analysis

(76) Inventor: Michael Hans Dehn, Plainville, MA (US)

Correspondence Address: Michael Hans Dehn, 23 Horseshoe Drive, Plainville, MA, 02762, US

(21) Appl. No.: 12/477,165

(22) Filed: Jun. 3, 2009

(51) Int. Cl. G06F 17/30

(52) U.S. Cl. 707/706; 707/E17.108

(57) ABSTRACT

Techniques to permit a search engine's users to refine query results without prior assignment of the results to clusters are provided. After the user identifies a particular result as undesirable, the words present in the result are tabulated. A subset of these words that also occur with unusually high frequency within the other query results is selected for exclusion. The user's initial query is automatically repeated with these words excluded, thus increasing the proportion of results that the user judges as desirable.

### BACKGROUND OF THE INVENTION

The present invention relates to the refinement of search engine results based on a user's identification of a single undesirable result. A search engine user may also use the approach iteratively to achieve successive refinements until they are satisfied with their search results.

A textual search engine (for example, Google) is designed to take a query (a list of keywords input by the user), parse it, locate documents containing those words, and display a list of these results. Rather than merely returning this entire list of documents, however, a set of ranking criteria is typically used to return a list of those documents believed to have a high probability of being considered useful. (For instance, in the case of Google the maximum number of ranked results returned is approximately 1,000.)

Nevertheless, standard Internet search engines suffer from a notorious problem: Very often, user queries do return a list containing the desired web pages, but buried within a far larger number of less relevant and irrelevant results. Search engines rely on complex ranking algorithms designed to identify the results most likely to be useful and list these first. Despite the best efforts of the result-ranking algorithm, however, users still frequently waste much of their time searching the search results, since examining the results of a single poor query can consume more time than examining the results of many queries in which the algorithm functions well. Although users can typically immediately identify a typical result of a poor query as irrelevant even without having to view the actual page, current search engines that display lists of results are severely limited in their ability to accept dynamic feedback from the user, and are typically unable to accept this particular form of feedback at all.

Further improvements in ranking algorithms will only be able to partially address this problem for at least three separate reasons: First, some users will always attempt to rely on the ranking algorithm as a labor-saving alternative to constructing a better-focused query. For instance, both fans of the Pittsburgh Penguins hockey team and individuals interested in learning more about Antarctic penguins are apt to search on the same single keyword “penguins” even though they are seeking two vastly different sets of results. Since any ranking algorithm can at best present the results within each category that would be considered the most useful by one of the groups of users, the majority of results will often be irrelevant to any individual user. Second, even results on a single subject will often fall into multiple categories, yet posing a query that selects the category of interest would in many cases pose a considerable challenge to a user. For instance, individual pages on a single subject such as “Atkins diet” may include popular discussions, clinical results, and dieting advertisements—yet a typical user would find it difficult to specify an additional keyword to narrow the search to one of these subsets. Third, results may differ qualitatively, even in the case of results within a single category of a single subject. For instance, in the case of popular discussions of the Atkins diet, users may readily discern that many of the reviews fall into two quite distinct categories, highly positive and highly negative, yet this information can be even less readily reduced to a pattern of words suitable for a query.

In order to address this fundamental deficiency, some search engines have introduced techniques such as clustering analysis, in which the pattern of word occurrences in the query results is analyzed in an attempt to categorize the results. For instance, an analysis of the results for the query “penguins” would sort them into at least two categories, dealing with hockey and birds. Nevertheless, this approach has not been widely adopted, as it has a number of deficiencies of its own. First, it is a computationally intensive, and thus slower and more costly, process—yet most queries would not require such categorization. Second, it too is by its very nature imperfect; in some cases it will subdivide results too far while in others it will not subdivide them sufficiently, and it is not well suited to cases in which the query results fall on a continuum rather than in discrete clusters. Third, it is difficult to adapt this approach to the traditional output format consisting of a list of query results, as the information is best represented graphically by a Venn diagram showing which categories are subdivisions of others, overlap others, etc. Fourth, an attempt to provide category labels may actually provide less information than a user would gain from the listing for an individual query result in a traditional list-based search engine.

Thus, an alternative method by which many of the undesired results in a query can be cleared away with a single click should be welcomed by many users. In addition to saving users time when they attempt a difficult query, such a method may also save users effort, by offering a more convenient alternative to the use of current search engine “advanced search” windows. The use of such an existing advanced search option frequently requires substantial additional time and effort on the part of the user in order to deduce and type in the additional keywords or other criteria that will result in a more narrowly focused search.

In addition, users should welcome a method that is also capable of helping them to zero in better and faster on the results that each considers the most desirable even in cases in which most results are relevant to the subject. When used iteratively, this method actually has the potential to turn the large number of results in a broad query (such as the millions of results for the keyword “penguins”) into an advantage rather than a disadvantage.

Finally, advertisers may find such a method of particular value. For instance, search engines may derive much of their revenue from targeted advertisements: When a user's query includes a particular word, phrase, or combination of words and phrases, the search engine can automatically display a link provided by a specific advertiser promoting a related product or service. Thus, any technique that provides additional information concerning the user's actual interest would permit more relevant advertisements to be displayed, and thus benefit both the user and the advertiser. For instance, a company selling Pittsburgh Penguins sweatshirts may presently pay to have their advertisement displayed whenever a user types the keyword “penguins” even though only a specific subset of these users will actually be searching for information on the hockey team. A technique that allows the search engine to discriminate between hockey fans and individuals interested in birds would eliminate this fundamental inefficiency. At present, advertisers are unable to rely heavily on negative keywords for their targeting because search engine users frequently do not use this type of keyword, but this situation would change if negative keywords were automatically generated.

### SUMMARY OF THE INVENTION

The present invention provides innovative techniques for allowing a search engine user to increase the proportion of query results they consider most desirable, with a single click, even in cases in which the results are not strongly clustered. Although refinement of the query results is based on user feedback, users are not required to think like a textual search engine by identifying additional desirable and/or undesirable words. The technique may be used following queries performed with either standard or advanced search windows, and users may obtain further benefit by using the feature iteratively.

The search engine begins by displaying an additional link accompanying each of the results to the user's query. If the user is not sufficiently satisfied with the query results and clicks on the link accompanying any one of the results that they judge particularly undesirable, the search engine performs a three-way comparison of word occurrences. Using information from the undesired result, the other query results or a representative subset thereof, and a representative sample of all possible results (in the case of Internet queries, a sample of the World Wide Web as a whole), it identifies a set of words present in the undesired result that are most likely to also be present in other undesired results. Specifically, if a word in the undesired result is much more common in the other query results than in all indexed documents, its presence in other query results is deemed likely to indicate that these results are also undesirable in that particular user's value judgment.

Once a set of words best able to reduce the proportion of undesirable results is identified, the search engine automatically executes a revised version of the user's original query in which these additional words are excluded. Since such additional words are required to be relatively unusual in documents not satisfying the initial query, these words need not be among the commonest words in the undesired query result or the other query results. In fact, even a handful of words that are each present once in the undesired result and once in only 10% of the initial query results may prove effective at eliminating most of the highest-ranking results.

Other features and advantages of the invention will become readily apparent upon review of the following description in association with the accompanying drawings.

### BRIEF DESCRIPTION OF THE DRAWINGS

FIG. 1 is a high level flow diagram of an exemplary method that may be used to preferentially remove undesired query results in the case in which forward indexes of webpages are available.

FIG. 2 is a high level flow diagram of an exemplary method that may be used to preferentially remove undesired query results in the alternative case in which forward indexes of webpages are not available.

FIG. 3 shows an example of the manner in which information accessed by the invention may currently be represented internally by a search engine.

FIG. 4 is a system diagram of an embodiment of an information retrieval system providing for query revision according to one embodiment of the present invention.

FIG. 5 shows an example of results for a query before and after the user selects a page as the basis for an exclusion.

### DETAILED DESCRIPTION OF PREFERRED EMBODIMENTS

The present invention will be described in reference to embodiments that automatically identify and exclude potentially undesirable Internet search engine query results. However, embodiments of the invention are not limited to any particular environment, application, or specific implementation. Therefore, the description of the embodiments that follows is for purposes of illustration and not limitation.

Search engines typically traverse the World Wide Web and construct numerical indexes reflecting the contents of the webpages they encounter. In order to deliver results promptly, this process involves the compilation and storage of several different types of lists or databases.

First, it is necessary for the search engine to generate an index of the words present in each particular webpage, which may be referred to as the “forward” index. This process typically also involves certain additional operations such as the removal of “stopwords” (words such as “the” which are of no interest) and “stemming” (the conversion of variations on a word, such as “cat” and “cats,” to a single form of the word) designed to create more usable results. In addition, a weighting process (taking into account factors such as the number of occurrences of the word within the page, location in the document, font size, etc.) may be performed. Consequently, in addition to a listing of each unique word present in a particular webpage, the forward index typically also contains additional information such as the location and potential importance of each occurrence of the word within the page.

From this forward index, the search engine updates its “reverse” or “inverted” indexing, which lists the URL of each webpage in which a particular word occurs. The search engine is then able to consult this index in response to a user's query for webpages containing that word. In addition, the search engine constructs a lexicon listing every unique word that it has encountered, along with any desired additional information such as the total number of webpages on which each word occurs.

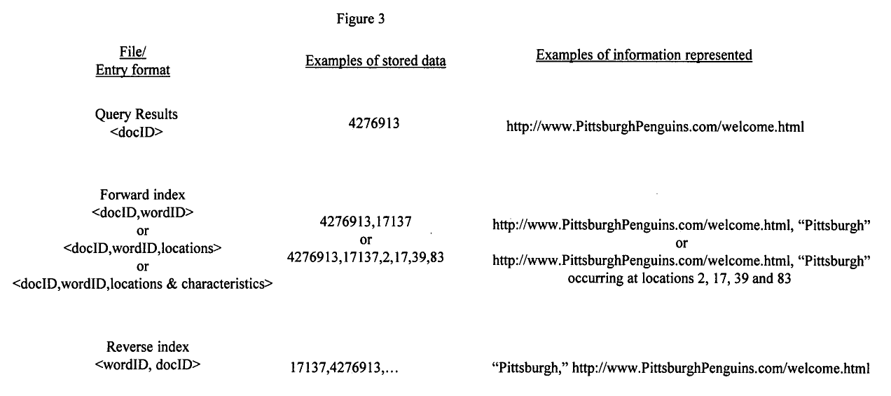

In order to facilitate storage and processing, the above indexes typically use numerical representations of the actual words and webpage URLs, often denoted as wordIDs and docIDs, respectively. Hypothetical examples of such representations are shown in FIG. 3. For instance, in the case of the webpage “http://www.PittsburghPenguins.com/welcome.html” the URL would be referenced through use of its assigned docID of 4276913, and the word “Pittsburgh” within this webpage would be referenced by its assigned wordID of 17137. For clarity, however, subsequent discussion will refer to the URLs and words that these variables represent, rather than to the wordIDs and docIDs actually used in the computation.

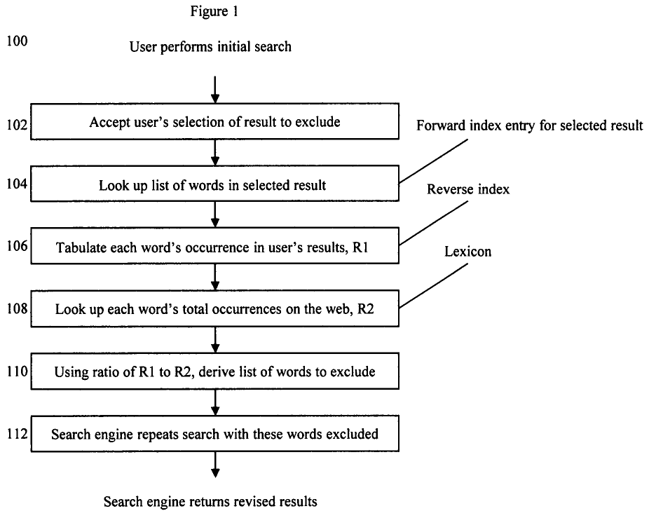

FIG. 1 illustrates the steps that may be taken if the search engine permanently stores the list of words in a webpage (i.e., the forward index of the page). While it would be possible for all of the operations to be carried out by the search engine itself, the search engine may alternatively use a separate query reviser to perform the operations involved in narrowing the result list.

In step 100, when the search engine displays the list of webpages satisfying the user's query, it also displays an additional link accompanying each of the URLs. Clicking on one of these links will permit the user to identify that URL as particularly undesirable. Thus, the link may be denoted by appropriate text or graphics such as “Exclude similar results,” an icon showing a downward-pointing thumb, a red X, etc. If an icon such as an “X” is used, the added links would add little “clutter” to the list of query results. Furthermore, in cases in which the user is satisfied with their initial query and does not use any of the added links, no additional actions that reduce the computational efficiency and delivery speed of the search engine would be taken.

However, when the user is dissatisfied with their query results, the present invention is designed to permit the user to efficiently provide the search engine with the results of a complex subjective judgment based not only on the large amount of information available to the user in the selected URL's title and the displayed “snippet” of text from the document, but in the information for all of the query results on the results list. For instance, by identifying the single least desirable result in a set of 10 even when all are moderately appropriate, the user may guide the search engine in homing in on a more suitable set of pages. In contrast, the “similar results” links currently accompanying individual URLs in some search engines are less useful since they require the user to first read through enough results to reach one possessing the high quality they desire—often a time-consuming process.

In step 102, when the user clicks on the link, the browser returns the necessary information to the search engine, specifically the URL to be excluded and any necessary information regarding the user's initial query.

In step 104, the search engine (or its revision server, if separate) then identifies the words present in this webpage by consulting the forward index created when the page was most recently indexed.

In step 106, for each word from step 104, the search engine then determines R1, the number of occurrences of the word in a sample of the user's remaining results, by a similar process. Words present in the initial query are ignored in this and subsequent steps. If the search engine has not cached the list of query results originally sent to the user, the search engine will begin this step by recreating the result list (i.e., re-executing the initial query); this result list would be temporarily cached (stored) for use in this and subsequent steps rather than sent to the user.

The search engine may analyze either the number of query results in which the word is present or the total number of occurrences of the word within all of the results. In the latter case, a rare word would be accorded even greater significance if it occurs repeatedly within individual webpages in the results.

If desired, the search engine may estimate the frequencies with which words occur in the query results by analyzing only a fraction of the results (such as a random sample of the results, or the most highly ranked results) in order to speed up computation. The maximum size of the sample analyzed in this step would typically be a predetermined constant. It is expected that relatively good results will typically be obtained by analyzing approximately 10^{1.5} to 10² webpages. Under these circumstances, significant errors may still be present in the frequency ratios of words that occur only occasionally in the user's query results, but this would be acceptable because such words would permit the exclusion of fewer undesired results and would thus be of lesser usefulness.

In step 108, for each word from step 104, the search engine then determines R2, the number of occurrences of the word in either the web as a whole or a representative sample of it. For efficiency, this could be accomplished by consulting a previously cached list of word frequencies, rather than deriving the frequencies each time a query revision is processed. For instance, if the lexicon already lists the total number of webpages in which each word appears, the search engine would use this to look up the appropriate value for each word. Alternatively, if this information is not stored in the lexicon, the search engine would merely need to create such information once prior to the first query, or periodically if desired, from a random sample of the web. Again, either the total number of webpages containing the word or the total number of occurrences may be used, and this choice need not match the comparable choice made in step 106.

In step 110, for each word in step 104, the search engine derives a ratio representing the relative frequency of occurrence of the word within the query results, by dividing the results of step 106 (R1) by the results of step 108 (R2). The words are then ranked on the basis of this ratio.

In the simplest case, words in the selected page are ranked simply by the ratio R1/R2, i.e., [occurrences of the word in the query results]/[occurrences of the word in the web as a whole]. Alternatively, it may be advantageous to introduce an additional quality factor that takes into account the number of results that a given word would eliminate. For instance, if the word with the highest ratio eliminates 1 other page but the word with the second-highest ratio eliminates 100, the second word may be the most useful.

If so desired, implementing such a quality factor would merely require replacing the abovementioned ratio with the following expression: ratio*[number of pages eliminated]”. The exponent n would be a constant whose optimal value could be determined empirically, based on user satisfaction ratings. The most useful value of n need not be 1; it is equally possible that a weaker, non-integral weighting such as 0.5 would prove best.

Once the words in the undesired webpage have been ranked in order of their usefulness in excluding other query results, the search engine selects the most highly ranked word or words. For instance, the top 20 words may be selected, or every keyword present at least 20 times oftener than expected. Again, optimal values are best determined empirically (based on user satisfaction ratings) rather than theoretically.

Alternatively, the search engine may permit the user to alter the number of words to be used (for instance, by moving a slider higher or lower depending on the fraction of results they wish to exclude in their query revision). In this fashion, the user would in effect be able to control how narrowly or broadly to interpret “similar,” by influencing the appropriate parameter used by the algorithm (either the number of keywords excluded or the minimum frequency ratio, depending on which of these cutoff values described above is implemented in the search engine).

It may also be beneficial to require that more than one unusual word from the set of high-ranking words be present in order for a result to be excluded. Increasing this value from one to two may in certain cases prevent a significant number of mistaken eliminations, at the expense of failing to eliminate some pages that should be eliminated. If a much higher value than two is used, only pages that are the most similar to the undesired result will be eliminated—occasionally useful, but a disadvantage in most cases. Once again, the optimal value may be determined empirically based on user satisfaction.

Finally, in step 112, the search engine automatically executes a new query with the selected words excluded. Since the query result list will either have been cached in step 100 or recreated in step 106, this could be accomplished either by searching within the user's initial results (excluding the specified words), if feasible, or by performing a completely new query (based on the initial query and excluding the specified words). The latter technique may give somewhat better results, as judged by the user, since the ranking algorithm may select a different sequence of results when permitted to use the most comprehensive information concerning the user's wishes.

In certain cases, the algorithm may of course exclude inaccurately. For instance, in the case of a search for “penguins,” the words “ice” and “spring” may occur with unusual frequency in both hockey and bird results, leading to the exclusion of desired as well as undesired pages. The user may use their browser's “Back” button or a similar button displayed by the search engine to return to the previous result list. In order to further assist the user in cases in which a particularly high proportion of results are included improperly and/or excluded improperly, however, it may be advantageous for the search engine to also display a list of all of the automatically selected keywords and/or a list of all of the other keywords in the undesired result that appear with unusual frequency in the other results. This may provide valuable guidance to the user, by suggesting additional keywords that the user can manually specify for inclusion or exclusion in a new query.

Furthermore, if desired, the keywords in such an additional list could be displayed in the form of clickable links, to make it possible for users to add specific keywords from this list to the list of words to exclude, or delete specific keywords from this list, with a single click rather than having to retype the individual keyword or their entire query. In order to avoid unnecessary clutter on the search results page, the display of candidate exclusion keywords may be presented as an advanced option; a single link on the results page, when clicked on by an interested user, would display the two keyword lists.

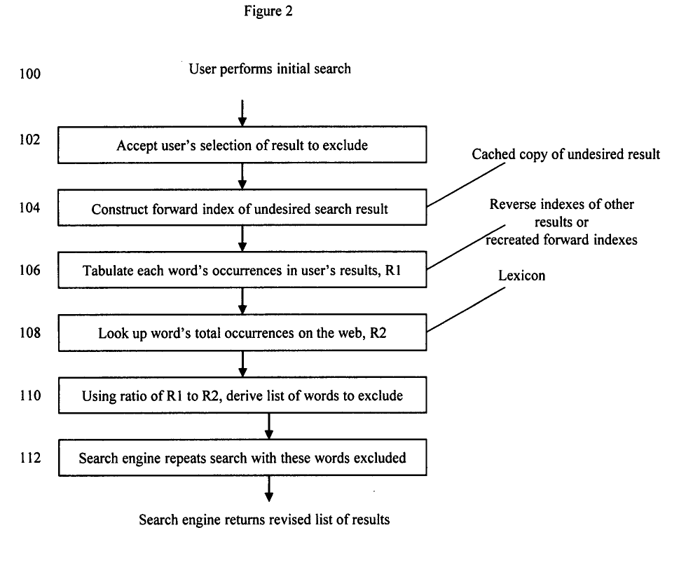

While the above embodiment relies on cached forward indexes of the user's query results, such indexes may not be available in all cases (i.e., if a particular search engine otherwise has little or no further use for the forward index, it would have been deemed inefficient to store this information). Thus, FIG. 2 illustrates one example of the steps that may be taken if the search engine does not cache the forward index. The flowchart differs from the previous implementation in steps 104 and 106.

In step 104, the search engine (or its revision server, if separate) must now recreate the list of unique words in the undesired webpage, rather than retrieving this information from a stored index. While this process would involve repeating some of the same steps performed during the original indexing of the webpage, in this case it may not be necessary to track any information (such as location or font size) other than the words present and, if desired, the number of occurrences of each word. In effect, the search engine would examine the cached copy of the page and parse it as before, but then merely generate a list of the words present. Thus, this process should be more rapid than the original forward indexing. Omission of the additional information would take advantage of the fact that the algorithm's overall performance is unlikely to be seriously degraded by not taking into account factors such as a word's location within the file or its font size.

Next, in step 106, the search engine could recreate the forward indexing of a sample of the other query results by the same process. Alternatively, the search engine could achieve the same result less directly by using the existing reverse indexing: By executing multiple queries (one for each word in the undesired result), each adding the word in question to the user's original query, it would be possible to determine the number of results that contained each of the words. Again, it may be advantageous to simplify and thus speed this process by omitting steps such as the ranking of the results and the display of the results to the user.

Since the process required in this step is considerably more involved than in the preceding embodiment, it may be particularly advantageous to achieve faster delivery of query results through the use of distributed processing. For instance, a representative sample of 50 webpages from the user's initial query results could be indexed as rapidly as a single webpage by employing a set of 50 query revisers, each of which is assigned to index one webpage. Likewise, it may be advantageous to achieve faster delivery of query results by performing the indexing on cached versions of the pages; if any of the pages have changed since caching, this may result in slightly different rankings of words to exclude, but such differences can typically be expected to be minor.

Since it is typically important that search engines return query results rapidly, a search engine may also speed the delivery of the results to common queries by storing the information generated by each exclusion request, if desired. For instance, if a strategy of constructing forward indexes of the sample webpages is used, subsequent calls to the exclusion algorithm described in the present invention may begin by querying the list of webpages for which forward indexes have already been stored, and using this information if available. Only if the webpage has not previously been used in an exclusion (or if it is believed that the cached version of the page may have changed significantly since the reindexing) would it be necessary to reindex the page (and subsequently store the forward index results and update the list of forward-indexed pages accordingly). Note that this process may actually require reindexing only a very small fraction of the webpages cached by the search engine, as most webpages will never rank within the top 1,000 results of any user's query, yet in this case it has the potential to speed the large fraction of user queries that repeat earlier queries.

If desired, it may also be possible to achieve a modest further increase in processing speed by a strategy of storing the list of words resulting from an exclusion. For instance, if a user searches for the word “penguins” and then clicks to exclude the first result because it pertains to the Pittsburgh hockey team rather than birds, the search engine could cache the list of words to be excluded, and use this in future queries in which a user inputs the same “penguins” keyword and chooses to exclude the same result. This strategy would take advantage of the fact that a large fraction of queries repeat common single keywords, and that any users performing exclusions to narrow the results will frequently select one of the initial webpages in the result list. It also takes advantage of the fact that the overall pattern of such queries typically changes only slowly with time—For instance, in the “penguins” example, the bird results will still contain words such as “feathers” and the hockey results will still contain words such as “hockey,” and even hockey player names will usually change only from year to year, so a sufficiently similar ratio of desired to undesired results could be achieved even if many of the webpages used in the analysis would be considered too outdated to be of use for the query itself. However, “volatile” webpages (those that change frequently) would suffer from a loss of accuracy.

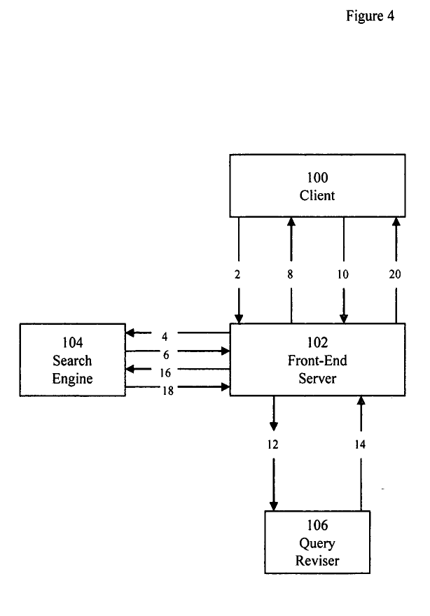

FIG. 4 illustrates a system in accordance with one embodiment of the present invention. The system comprises a front-end server 102, a search engine 104, and a query reviser 106. During operation, the user accesses the system via a conventional client 100 (such as a personal computer accessing the search enigine via a web browser program) over a network. While only a single client 100 (i.e., a single user) is shown, the system can of course support a large number of concurrent sessions by different users.

The front-end server is responsible for receiving an initial search query submitted by the user, client 100 (line 2). The front-end server then provides the initial search query to the search engine 104 (line 4), which evaluates the query, retrieves a set of initial results in accordance with the query, and returns the results to the front-end server 102 (line 6). This procedure is the same as that typically employed by present search engines. The front-end server 102 in turn transmits the query results page to the client 100, including the additional links previously described (line 8).

At this point the user may select one of the query results as the basis for an exclusion. After the user clicks on one of the links provided, the client 100 submits the link indicating the desired revision to the front-end server 102 (line 10), which in turn submits the information to the query reviser 106 (line 12). The query reviser obtains indexing information for the webpages in the initial result list (either directly from an existing index, not shown, or if necessary by sending additional queries to the search engine). After constructing the revised query, the query reviser 106 then returns this information to the front-end server 102 (line 14), which in turn submits it to the search engine 104 (line 16). The search engine returns the revised query results to the front-end server 102 (line 18), which in turn transmits the revised query results page to the client 100 (line 20).

Since each result in the revised query result page again has an associated link permitting the result to be used as the basis for an exclusion, the user may use such a link to repeat the process.

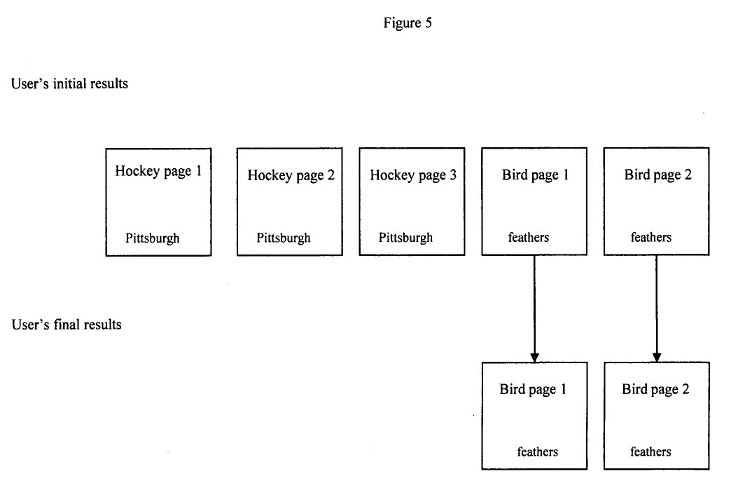

FIG. 5 illustrates a hypothetical query in which a user interested in the penguins of Antarctica has input the keyword “penguins” and received an initial list of results. After glancing at the first result, “Hockey page 1,” the user is immediately able to determine that it is irrelevant, and clicks on the link accompanying it. When the list of words present in this webpage is analyzed by the search engine, it is found that the word “Pittsburgh” occurs far more frequently in the user's other query results than in the web as a whole. Accordingly, a revised query is automatically performed in which the keyword “penguins” is still required but occurrences of “Pittsburgh” are not permitted. The user receives a new list of results in which all three hockey pages are now excluded but the bird results remain. A generally similar pattern would likely have resulted if alternative keywords such as “hockey,” puck,” “goal,” “score,” “team,” etc. had been used (either instead of or in addition to “hockey”), while the opposite result would have resulted if the user had selected a bird result as undesirable and the search engine had excluded all results containing keywords such as “feathers,” “Antarctica,” “ocean,” “water,” etc.

In order to evaluate the performance of the invention, approximately 60 webpages selected as the best results for the keyword “penguins” by a commercial search engine based on clustering analysis (Ixquick) were downloaded, along with approximately 540 unrelated webpages intended to simulate the web as a whole. The Ixquick search engine attempts to identify a small number of best results in each of a number of result clusters, and thus gives a result list that is especially diverse. This case should therefore be of particular interest because it represents a more stringent performance challenge than the highest-ranking results from a standard search engine such as Google, which fell into fewer and more homogeneous groups for the same search.

Following the initial search of these pages for “penguins,” exclusion of a single bird result typically reduced the number of bird results by nearly an order of magnitude while eliminating somewhat less than half of the other results (some of which did also deal peripherally with birds). Thus, even without optimizing any of the potentially adjustable parameters, undesired results were excluded approximately five times more frequently than desired results. In an independent test using Google results, the reverse process—elimination of hockey pages that outnumbered bird pages several-fold—typically increased the ratio of desired to undesired results ten-fold. Thus, as expected, the method worked effectively precisely when it was most needed: when the great majority of query results were on an irrelevant subject.

Some desirable results were eliminated by mistake, and conversely, some undesired results were not excluded even though they possessed certain similarities to the specified result. Nevertheless, as would be the case in most searches, it was not a problem for the method to mistakenly eliminate a modest fraction of desired results, or to fail to eliminate the occasional undesired result: The method's purpose is to markedly improve the proportion of desired results, by eliminating a much larger fraction of undesired results than of desired results. Thus, it speeds the user's examination of the list of results by increasing the overall quality of the most highly ranked results.

1. A method for automatically refining search engine results based on a user requesting a search and then identifying a single, typical query result as undesirable or particularly undesirable. This comprises identifying words present within this result that occur with unusually high frequency within the other query results, and executing a revised query in which results containing certain of these words are excluded.

2. The method of claim 1, wherein the frequency of occurrence of a keyword is based on the total number of query results within which that word occurs at least once.

3. The method of claim 1, wherein the frequency of occurrence of a keyword is based on the total number of occurrences of that word, such that multiple occurrences of the word within a single document correspond to a higher frequency of occurrence than would a single occurrence within the document.

4. The method of claim 1, wherein keywords in the undesirable result are excluded in the revised query whenever they occur a predetermined number of times more frequently within the query results than within a representative sample of all possible search results.

5. The method of claim 1, wherein a predetermined number of keywords in the undesirable result are excluded in the revised query, and wherein the keywords selected are those in which the ratio between the keyword's frequency within the query results and the keyword's frequency within a representative sample of all possible search results is the greatest.

6. The method of claim 1, further comprising the calculation of a quality factor based on the number of query results containing the keyword, as a means of enabling the number of query results that will be excluded to be maximized.

7. The method of claim 6, wherein the keywords to be excluded are selected on the basis of the quality factor multiplied by the ratio between the keyword's frequency within the query results and the keyword's frequency within a representative sample of all possible results.

8. The method of claim 6, wherein the quality factor is equal to the number of query results containing the keyword raised to an integral power such as 1 or a non-integral power such as 0.5.

9. The method of claim 1, wherein exclusion of a result requires the presence of more than one word from the list of excluded keywords.

10. The method of claim 1, further comprising creating a means by which the user may adjust the number of keywords that will be excluded in subsequent query revisions.

11. The method of claim 1, further comprising displaying a list of the excluded keywords and a list of other candidate keywords occurring with unusual frequency in the initial query results.

12. The method of claim 11, wherein the keyword display consists of active links that the user may click on, in order to automatically transfer a keyword between the two categories (the keywords excluded in the revised query, and the keywords not excluded in the revised query), prior to executing a further revision of the query.

13. The method of claim 1, wherein the list of keywords resulting from a search is stored, and made use of when future users perform the same search and select the same page to be excluded.

14. A computer program product for automatically performing the steps described in the preceding claims.
